(19) United States
(12) Patent Application Publication
(10) Pub. No.: US 2007/0051598 A1
(43) Pub. Date: Mar. 8, 2007

(54) Child safety lock system

(76) Inventors: Matthew Richard alex Nye-Hingston, Auckland (NZ); Neil Richard Hingston, Auckland (NZ)

Correspondence Address: JACOBSON HOLMAN PLLC, 400 SEVENTH STREET N.W., SUITE 600, WASHINGTON, DC, 20004, US

(21) Appl. No.: 10/577,056

(22) PCT Filed: Oct. 22, 2004
(86) PCT No.: PCT/NZ04/00263

§ 371 Date: Jul. 24, 2006

(30) Foreign Application Priority Data
Oct. 23, 2003 (NZ) 529152

(51) Int. Cl. B60R 25/00; E05B 53/00; H01H 9/22

(52) U.S. Cl. 200/50.02; 312/218; 340/5.7

(57) ABSTRACT

A series of locks are described for preventing child access to cupboards and the like. The locks are preferably concealed and are opened by a proximity of a remote actuator, for example a magnet actuating a reed switch. An override or master switch may also be used to open all locks, for example, for a set period while emptying a dishwasher.

### FIELD OF THE INVENTION

The present invention relates to a cabinet lock and a cabinet including such a lock which in particular although not solely is provided for the purposes of providing a safety locking system for preventing children or other undesired access to the interior of a cabinet.

### BACKGROUND ART

Access to certain goods or property often needs to be limited or controlled. For example in a domestic situation cleaning products or other chemicals are often stored in kitchen cabinets. Where children or toddlers are able to reach such locations it becomes essential for access to the storage regions of the cabinets to be controlled and in most situations to be secured so as to prevent a toddler from gaining access to such locations. However some such kitchen cabinets are in frequent use by adults and it is not desirable for the manner in which access is restricted to the cabinets to be cumbersome or difficult to achieve. It is however desirable for any mechanism to lock the cabinets to be provided internal of the cabinets. It normally does not take long for a toddler to figure out how an external locking arrangement may be rendered ineffective and it is hence desirable for any locking mechanism to be provided internally of the cabinet and hence out of sight of any enterprising toddler. An issue which will arise by having a locking mechanism mounted internally is that access to such will then also be difficult to obtain by an adult who does wish to have access to the interior of the cabinet. Electric latching devices actuated from external of a cabinet such as that disclosed for example in WO97/02399 can be utilised for such purposes. It is however desirable to operate any electric mechanisms in a manner where minimal power is consumed. Since in most circumstances the cabinet doors or drawers will be in a closed condition, in such a default condition it would be undesirable for continuous power to be drawn by a locking unit. In addition however it may be desirable that the locking arrangement is made redundant and that free and unfettered access to the cabinet can be achieved. Such may be desirable for a significant duration of time and it would be undesirable for the locking device to, during such periods of time, be drawing power from a power source in order to achieve such an unlocked position. It is accordingly desirable to be able to isolate the locking device in a condition where it does not provide a restriction to the opening of a cabinet yet still not draw a significant amount of power from the power source when operated in such a condition. Indeed where a single power source may provide power to several locking devices for different cabinet doors or drawers it may be desirable that for significant durations of time one or more of the locking units is in such a condition where it does provide operative locking to the door or door with which it is associated.

### SUMMARY OF THE INVENTION

It is therefore an object of the present invention to provide a cabinet lock which addresses the abovementioned desiderata or which will at least provide the public with a useful choice.

Accordingly in a first aspect the present invention may be broadly said to consist in a locking system for preventing child access to a cabinet, cupboard or drawer comprising:

a power supply configured to energise a plurality of locking systems,

a locking mechanism actuatable to unlock said cabinet, cupboard or drawer when energised,

an at least partially concealed switch electrically coupled between said power supply and said locking mechanism, and

a remote actuator held by a user whereby bringing said actuator in proximity to said switch causes said switch to close thereby energising said locking mechanism from said power supply and unlocking said cabinet cupboard or drawer.

Preferably said system comprises a single power supply and a plurality of locking mechanisms and switch actuator combinations.

Preferably said switch is a reed switch and said actuator is a magnet.

Preferably said switch is a radio receiver and said actuator is a radio transmitter or interrogable device.

Preferably said locking system returns to a locked position when said actuator is non proximate said switch.

Preferably a system comprising an override connection which may be connected to bypass said switch and thereby connect said locking mechanism directly to said power supply.

Preferably a system comprising an override switch which when actuated connects said override connection to said power supply thereby energising each locking mechanism.

Preferably an override switch connects said override connection to said power supply for a predetermined period.

Preferably said locking mechanism is a solenoid which activates a latch bolt which engages a striker within a stationary portion of said cabinet cupboard or drawer.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following give examples.

### BRIEF DESCRIPTION OF THE DRAWINGS

A preferred form of the invention will now be described with reference to the accompanying drawings in which:

FIG. 1A is a perspective view of part of a cabinet including part of the compartment structure with which the latch bolt assembly is engaged and part of a drawer with which the striker is engaged showing the latch bolt assembly and the striker in a position for locking together,

FIG. 1B is a perspective view of the configuration of FIG. 1A but wherein the drawer has been moved relative to the compartment structure and is in an unlocked and disengaged condition,

FIG. 2A is a perspective view of a cabinet wherein the closure is a cabinet door rather than a drawer as shown in FIGS. 1A and 1B and wherein the door is in a locked position with the compartment structure of the cabinet,

FIG. 2B is a perspective view of FIG. 2A wherein the cabinet door is in an unlocked and partially opened condition relative to the compartment structure of the cabinet,

FIG. 3A is a perspective view of the striker and wherein the interference tongue is in a non-interference condition thereby allowing for the bolt of the latch bolt assembly to penetrate the aperture of the striker,

FIG. 3B is a perspective view of FIG. 3A but wherein the interference tongue extends across the aperture of the striker, and

FIG. 4 is a perspective view according to a first embodiment of a plurality of cabinet locks the striker bolt assemblies of which are in a chain relationship relative to each other and relative to a power source and wherein each includes its own designated switch for individual actuation,

FIG. 5 is a circuit diagram of the first embodiment of the present invention,

FIG. 6 is a perspective view according to a second embodiment of a plurality of cabinet locks the striker bolt assemblies of which are in a chain relationship relative to each other and relative to a power source and wherein each includes its own designated switch for individual actuation,

FIG. 7 is a circuit diagram according to the second embodiment of the present invention, and

FIG. 8 is a perspective view of the latch bolt and strike according to the second embodiment of the present invention.

### DETAILED DESCRIPTION

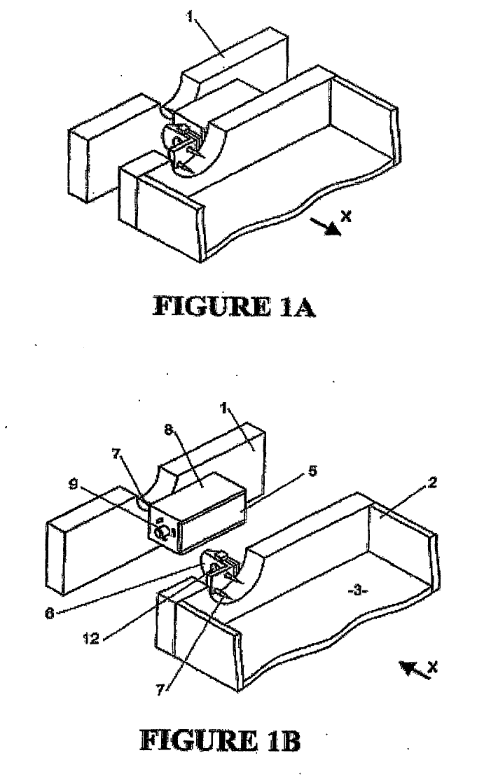

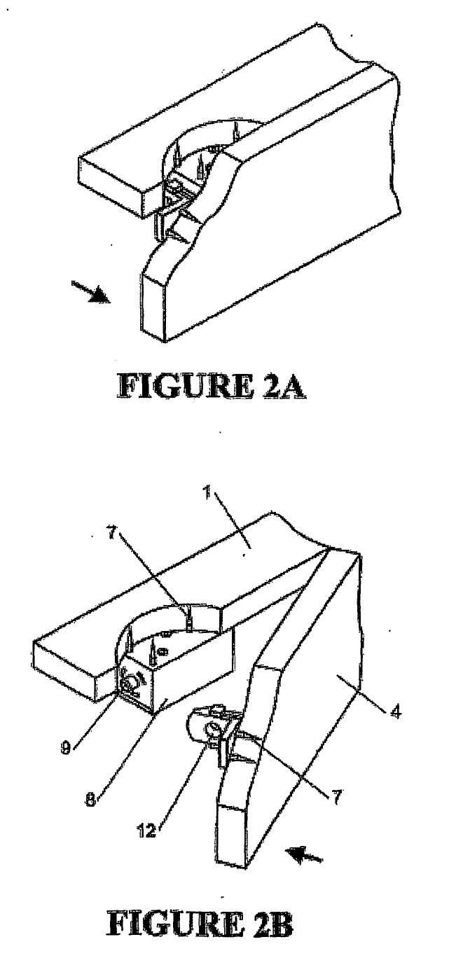

With reference to FIG. 1B there is shown part of a cabinet which includes a compartment structure 1 and a drawer 2 which is movable relative to the compartment structure in a linear fashion and for example in direction X relative to the compartment structure 1. The compartment structure 1 may include a back wall of the compartment with which part of the cabinet lock is engaged. The drawer 2 can extend but yet be drawn from the compartment structure 1 to expose the drawer containment region 3 to the exterior of the compartment structure 1. In an alternative form the cabinet lock of the present invention may be utilised where a door 4 is pivotally movable relative to the compartment structure 1 which with reference to FIG. 2B may for example be a shelf or top wall member of the fixed compartment structure. The door 4 will be pivotally dependent to the compartment structure so as to be able to open and close an opening to the compartment structure to thereby allow and prevent access to the interior of the compartment via such an opening. The cabinet lock of the present invention consists of a latch bolt structure 5 and a striker 6. One or the other of the latch bolt structure 5 or striker 6 is engaged to the compartment structure 1 or to the closure device such as the drawer 2 or door 4. In the most preferred form and as shown in the drawings the latch bolt assembly 5 is engaged to the compartment structure 1 and the striker is engaged to the drawer or door 2, 4. The latch bolt assembly 5 is preferably engaged to the compartment structure 1 by means of fasteners 7 such as screws. Likewise the striker is engaged to the drawer or door by fastening elements such as screws 7. Some of the screws 7 have been revealed by the partially cutaway view of the portions of the cabinet at where such are affixed. Alternative means of fastening can be provided such as for example by way of adhesive, bolts or by other mechanical means.

The striker 6 is provided in a location with the drawer or door 2, 4 such that when the drawer or door is positioned relative to the compartment structure 1 to close the opening to the cabinet, the striker is in a proximity to the latch bolt assembly 5 to allow for them to become engaged with each other. The latch bolt assembly 5 preferably includes a mounting 8 which carries therewith a bolt 9. The bolt 9 is movable relative to the mounting 8 and hence also to the compartment structure 1 between a condition locking and a condition unlocked. Such a movement is preferably a linear movement. In the most preferred form movement at least from a direction locked to the direction unlocked is actuated by an electromagnetic configuration of the latch bolt assembly 5. Movement of the bolt 9 from the unlocked position to the locked position may be achieved by a biasing element such as a spring within the mounting 8 which urges the bolt 9 from the unlocked position to the locked position. With reference to FIG. 1B the locked position is a position where the bolt 9 protrudes from or to a greater extent from the mounting 8 than in the unlocked position. In the unlocked position the bolt 9 may be retracted within the housing of the mounting 8 or may protrude therefrom to a lesser extent.

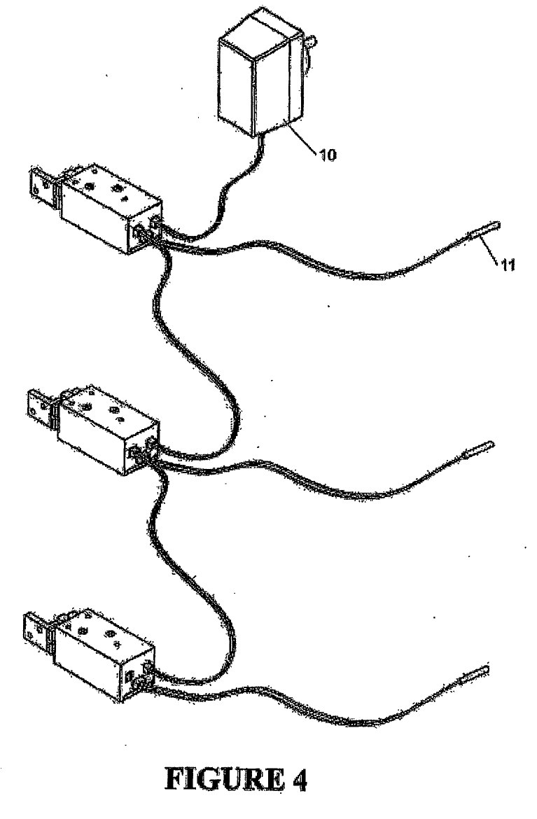

The latch bolt assembly is preferably engaged via wiring as for example shown in FIG. 4 to a power source 10. The power source 10 may be a transformer deriving power from mains electricity. Power is drawn from the power source by the cabinet lock of the present invention preferably only during the movement of the bolt 9 from the locking position to the unlocking position. A coil within the mounting 8 may be energised upon the actuation of a switch 11 which controls the delivery of power from the power source 10 to the coil within the mounting 8. With the use of a ferrous bolt 9 extending through the coil (not shown) of the mounting 8 and upon its energisation the bolt 9 can be drawn from the locked position as shown in FIG. 1B to an unlocked position. Once the delivery of power to the cabinet lock is terminated the bolt is again urged towards the locked position. In the locked position, the bolt 9 engages with the striker 6 in a manner to become engaged therewith. Such engagement is to prevent the movement of the latch at least in a direction lateral to the direction of movement of the bolt 9 between its locked and unlocked positions. Accordingly in the most preferred form the striker presents an aperture 12 which may be a through hole or a blind hole in the striker plate of the striker 6 and into which the bolt 9 can penetrate. Such penetration and when in the locked position of the bolt 9 will prevent the striker 6 from moving a direction lateral to the penetrative direction and thereby accordingly will prevent the cabinet drawer or door from opening. It will be appreciated that whilst in the most preferred form it is an aperture 12 which provides a surface against which the bolt will engage to prevent the cabinet door or drawer from opening, it may alternatively be a rebate, recess, upstand, blind hole or any other region of the striker which presents a surface to present interference to the movement of the striker in the direction lateral to the penetrative direction of the bolt 9.

In the most preferred mode of operation the bolt 9 and in its natural condition is biased towards a locking position as shown in FIG. 1B where the bolt extends furthermore from the mounting 8 than in the unlocked position. Electromagnetic actuation is employed to move the bolt from the locked position to an unlocked position. Since in normal use, a kitchen cabinet remains predominantly closed, and in such a condition it is desirable for the cabinet doors or drawers to remain locked and prevented from opening in order to ensure that minimal power usage occurs, the bolt 9 is preferably urged towards the locked position by means of a spring (not shown) which provides a bias to the bolt in and towards the locked position. The bolt in such a position is naturally biased towards the locked position however can be pressed back into the mounting 8 as and when desired. As such, no electromagnetic forces are pushing the bolt towards the locked position and it is merely the forces of a spring or gravity which hold the bolt in or towards the locked position. Hence no or minimal power consumption occurs.

Alternatively the bolt, affixed to the cabinet structure in a vertically extending direction may rely on gravity to bias it towards the locked position which would be in a downward direction. When it is desired for the cabinet to be unlocked and to allow for the drawer or doors to be opened electromagnetic actuation can be triggered to move the bolt from the locked position to the unlocked position. This will then retract the bolt from the aperture 12 and allow for the door or drawer to be opened. When the striker is displaced from the latch bolt, electromagnetic actuation may be terminated and the bolt may return to a locked position however such will then not be in engagement with the striker.

In moving the cabinet drawer or door back to a closed condition (closing the opening of the cabinet structure), in the most preferred form it is undesirable for an electromagnetic actuation to occur of the bolt 9 to move it back to an unlocked position to allow for it to then become aligned with the aperture 12 for subsequent penetrative engagement and locking therewith. Accordingly the striker 6 includes a guiding or camming surface 15 which upon the movement of the striker to align the aperture 12 with the bolt 9, engages with the distal end of the bolt 9. Further advancement of the striker for alignment of the bolt with the aperture 12, results in a sliding movement of the distal end of the bolt 9 over the camming surface 15. The camming surface 15 is presented at an angle to the direction of travel of the striker 6 during its movement with the cabinet door or drawer (and hence also at an angle to the lateral of the direction of movement of the bolt between the open and closed conditions). The angled surface 15 extends sufficient such that first engagement of the distal end of the bolt 9 with the striker occurs on the angled portion of the striker 15. Further advancement will move the bolt towards the unlocked position and will guide the bolt towards the unlocked position so as to allow it to be retracted sufficient to then penetrate the aperture 12 when the lateral alignment of the striker 6 with the bolt 9 has occurred. The bolt 9 being biased towards the locking position will remain in contact with the camming surface as it progresses therealong and towards alignment with the aperture 12. As soon as the bolt 9 is in alignment with the aperture 12, and under the influence of the bias, the bolt will penetrate into the aperture and thereby lock with the striker. Accordingly in a movement from the unlocked to the locked position there is no requirement for power by the electromagnetics of the present invention.

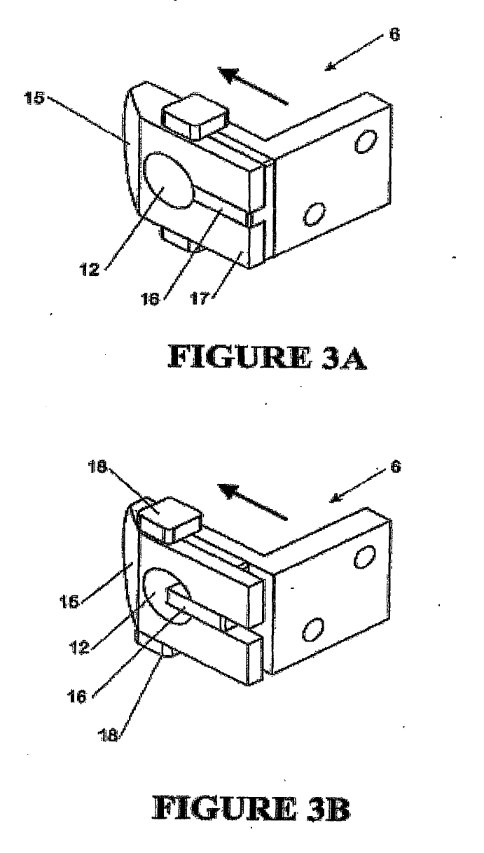

As has been mentioned the drawers or doors will normally be in a closed position and in such a closed position it is preferable that they are also in a locked position. It is as a consequence of such that the bolt 9 is normally biased towards its locked position such that when the striker presents the aperture 12 in alignment therewith the cabinet door or drawer is locked. However in some situations it may be desirable that a particular door or drawer and for example where a series of cabinet locks are provided, that some but not all of the doors or drawers are, when in a closed position, unlocked. It is desirable in such a situation that little or no power consumption occurs. As has been described movement of the bolt 9 from the locked position to the unlocked position involves the actuation of the electromagnetics thereby displacing the bolt to the unlocked position an improvement has been made to the striker 6 which will allow for a particular door or drawer to be unlocked yet require no or minimal power utilisation of the electromagnetics of the latch bolt assembly. With reference to FIGS. 3A and 3B, there is shown a tongue 16 which is moveably disposed from the fixed portion 17 of the striker 6. In particular it is moveably disposed relative to the aperture 12. The tongue 16 can move from a position where it provides no interference to the movement of the bolt 9 into penetrative engagement with the aperture 12 (shown in FIG. 3A) to a position where it does present interference to the movement of the bolt 9 into the aperture 12 (FIG. 3B). In the position of interference the tongue 16 prevents the bolt 9 from moving into the aperture 12 and thereby prevents the bolt 9 from assuming a position whereby it engages with the striker 6 to prevent the movement of the striker in a direction lateral to the movement of the bolt 9. Accordingly when the tongue 16 is in such an interference condition as shown in FIG. 3B, the door or drawer hence remains removable from its closed position to an open position. The bolt 9 becomes ineffective in locking the door or drawer and merely slides over the aperture 12 without penetrating therewith. As seen in FIGS. 3A and 3B, the tongue 16 is disposed from the fixed structure of the striker 6 in a manner slideable therewith. A pair of lugs 18 are associated with the tongue 16 which can be engaged by a finger or fingers of a user to manually move the tongue 16 between the interference and non-interference positions. The bolt 9 as a consequence of it being biased towards the locked position will engage with the tongue 16 in the interference position and will be pressed there against but will not penetrate the aperture 12. In such a configuration no power consumption is required to maintain the relationship between the latch bolt and the striker in an unlocked position. In the most preferred form of a cabinet which incorporates a cabinet lock of the present invention the striker 6 is positioned in such a location so that a user can have convenient access to operate the tongue 16 as and when desired.

Alternative configurations of a tongue or means for interference with the presentation of the aperture 12 for penetration by the bolt 9 may include a means to rotate relative to the fixed structure 17 of the striker 6 or the movement of part of the striker 6 which carries the aperture 12 itself. It may be that the portion of the striker 6 which carries the aperture is movable relative to that portion of the striker 6 which is secured to the door or drawer and the aperture 12 itself may for example be moved slightly up or down to thereby prevent it from coming in alignment with the bolt 9.

Switch Mechanism

Switch 11 is provided such that a child cannot open the cabinet door. There is a requirement therefore for the present invention not to have an obvious external switch for example push button as this would not be appropriate for preventing the child's access to the cabinet.

Examples of switch and actuator or key combinations would normally involve an internal switch where the actuator or key is operated externally and may or may not involve some form of contact with the switch itself.

With reference to FIG. 4 it can be seen that a cabinet lock of the present invention may be part of a system of cabinet locks which may lock more than one drawer or door of a cabinet. As can be seen a plurality of cabinet locks are capable of being utilised in a single or with multiple cabinets where multiple openings are closed by doors or drawers or similar. A single power supply 10 may feed power to all of the cabinet locks which may each be wired in parallel from the single power source 10. It will however be appreciated that actuation of each cabinet lock unit may be required independent of the other and accordingly each cabinet lock unit may be actuated in consequence of a designated switch 11. Such a switch 11 upon actuation will only trigger the electromagnetic actuation of the cabinet lock with which it is associated. It will not influence any of the other cabinet locks wired in parallel and as part of the overall system.

The switch 11 may for example be a reed switch which is actuated under the influence of a magnetic field. A person may carry with them a device which includes a magnet such as a permanent magnet which can be waved in proximity to the switch 11 thereby actuating the bolt to move from the locked position to the unlocked position. For example a parent may carry with them such a permanent magnet (for example as a necklace around their neck) for convenient access to be obtained to the cabinet via particular doors or drawers normally locked by the cabinet locks of the present invention.

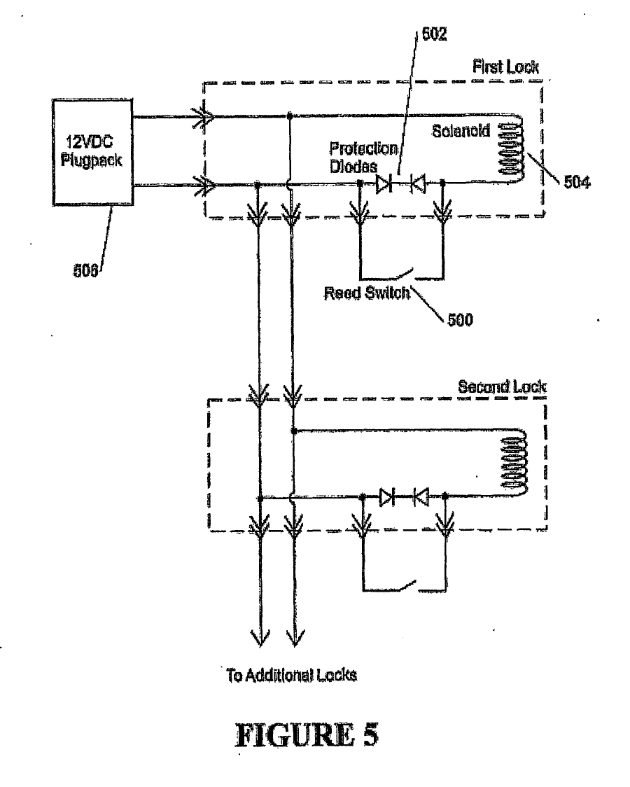

Referring to FIG. 5 each reed switch 500 has a back to back diode combination 502 in parallel as voltage protection. The reed switch 500 is in series with solenoid 504 activating the lock. Preferably power supply 506 is a 12 VDC supply with appropriate capacity for operating one solenoid at a time.

It will also be appreciated by one skilled in the art that a number of other switch and actuator or key combinations are possible. For example any form of radio frequency device, a remote control using infra red radiation, coded magnetic or electronic devices brought into proximity with the cabinet concerned are all considered within the purview of the present invention.

In a second embodiment a master switch 600 is included to improve the wiring system used by the locks 602. This master switch 600 provides a means of simultaneously unlocking several cupboards or drawers for a pre-set time. This would allow easy access when, for example, a dishwasher is being unloaded.

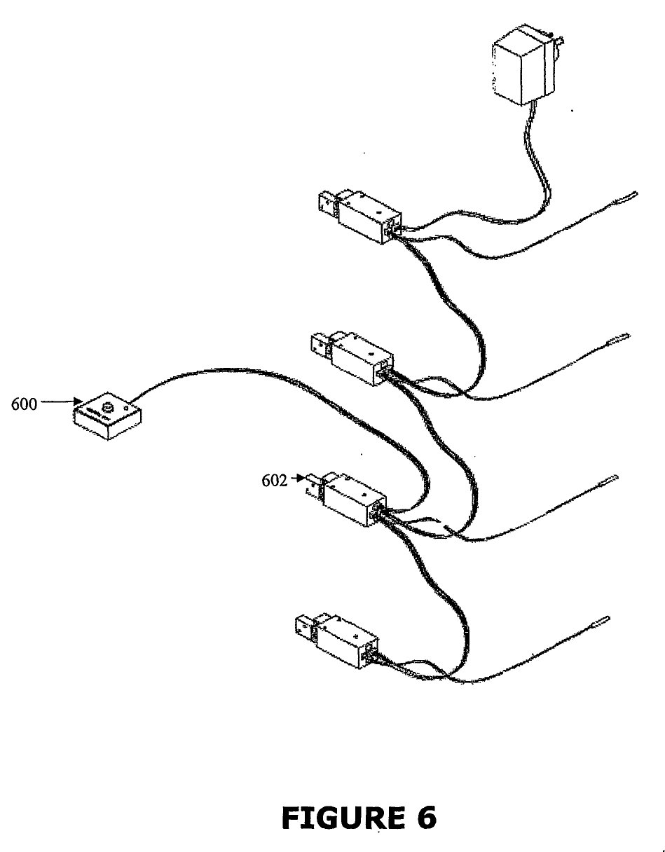

Referring to FIG. 6, this second embodiment has an extra wire running between all the locks 602 to connect the coils in parallel. A single switch 600 will energise them all. This switch 600 can have either a mechanical or electronic timer circuit as part of its function so that it opens after a pre-set time. Typically it could be say 5 minutes and may have selection for the length of time. This in no way effects the existing operation of the locks, as each one still works from its own reed switch. Also optionally a master lock or override button could be provided to instantly energise all locks.

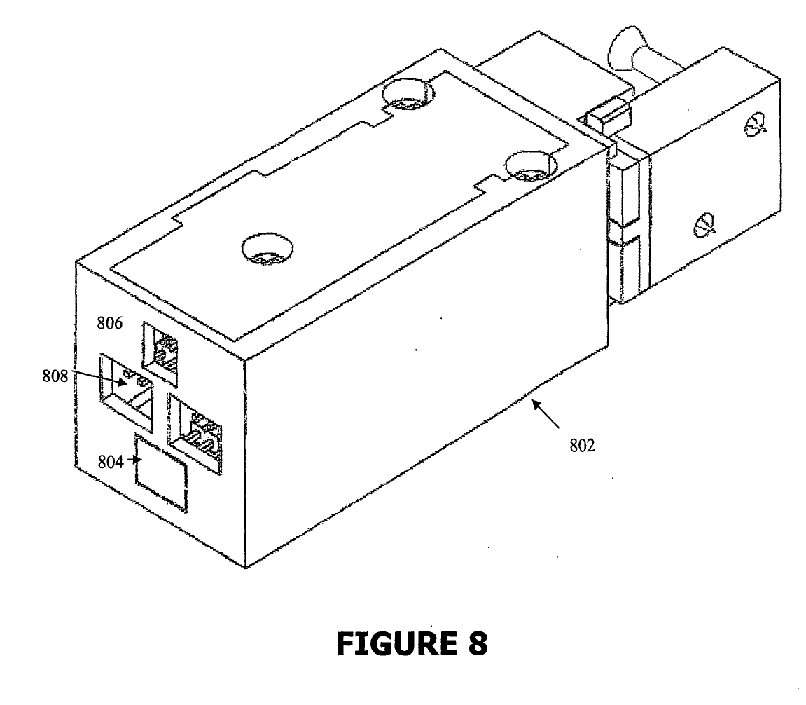

Referring to FIG. 8, the connection to the master switch can be added to any lock 802 in the system simply by breaking out a pre-cut hole 804 in the lock body 806, thereby exposing a connector 808 which the switch plugs into.

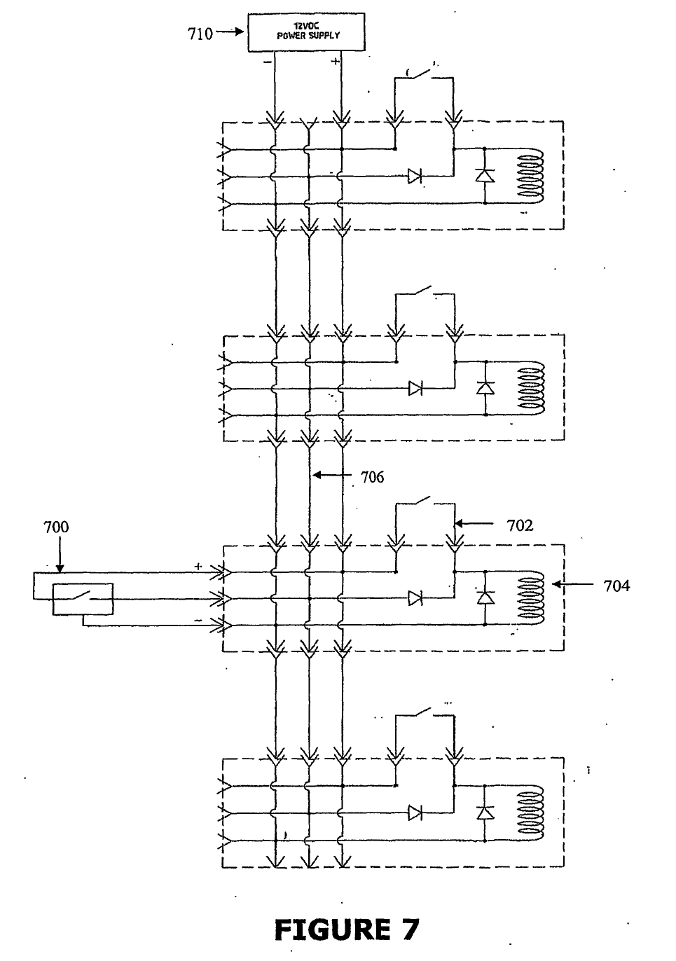

Referring to FIG. 7, a circuit diagram shows the master switch 700 connected in parallel with reed switch 702. With the master switch 700 closed reed switch 702 is short circuited and solenoid coil 704 energised from supply 710 thus opening the lock. This will energise all locks as there is a second supply line 706 paralleled through each lock which will short circuit the reed switch 702.

1: A locking system for preventing child access to a cabinet, cupboard or drawer comprising:
a power supply configured to energise a plurality of locking systems,
a locking mechanism actuatable to unlock said cabinet, cupboard or drawer when energised,
an at least partially concealed switch electrically coupled between said power supply and said locking mechanism, and
a remote actuator held by a user whereby bringing said actuator in proximity to said switch causes said switch to close thereby energising said locking mechanism from said power supply and unlocking said cabinet cupboard or drawer.

2: The system as claimed in claim 1 comprising a single power supply and a plurality of locking mechanisms and switch actuator combinations.

3: The system as claimed in claim 1 wherein said switch is a reed switch and said actuator is a magnet.

4: The system as claimed in claim 1 wherein said switch is a radio receiver and said actuator is a radio transmitter or interrogable device.

5: The system as claimed in claim 1 wherein said locking system returns to a locked position when said actuator is non proximate said switch.

6: The A system as claimed in claim 1 further comprising an override connection which may be connected to bypass said switch and thereby connect said locking mechanism directly to said power supply.

7: The A system as claimed in claim 6 further comprising an override switch which when actuated connects said override connection to said power supply thereby energising each locking mechanism.

8: The A system as claimed in claim 7 wherein said override switch connects said override connection to said power supply for a predetermined period.

9: The A system as claimed in claim 8 wherein locking mechanism is a solenoid which activates a latch bolt which engages a striker within a stationary portion of said cabinet cupboard or drawer.

10: (canceled)
